(19) United States
(12) Patent Application Publication
(10) Pub. No.: US 2004/0128906 A1
(43) Pub. Date: Jul. 8, 2004

(54) Fruit protective bag structure

(76) Inventor: Joe Jiang, Changhua Hsien (TW)

Correspondence Address: BACON & THOMAS, PLLC, 625 SLATERS LANE, FOURTH FLOOR, ALEXANDRIA, VA, 22314

(21) Appl. No.: 10/291,365

(22) Filed: Nov. 12, 2002

(51) Int. Cl. A01G 13/02

(52) U.S. Cl. 47/24.1

(57) ABSTRACT

An improved protective bag structure, having a protective bag body made up of an insulating yarn layer interlacing with a reflective yarn layer with a multiple of small air-penetrating pores distributed at the surface thereon. The protective bag body also has an opening end and three other sealed edges wherein the opening end has a gathering string adapted thereto to collect and seal up the protective bag body thereof without any other extra string required. Via the opening end, the protective bag body can be easily and quickly applied onto fruit to shelter it therein or removed from it. The insulating yarn layer thereof can absorb the ultraviolet ray of sunbeams, and the reflective yarn layer can send back sunbeams to protect the fruit sheltered therein from the damage of sunburn, facilitating the benefits of high air-penetrability, well ventilation of humidity, heat resistance, heat-sinking capability, and bug-proof. Moreover, a flexible gathering string can also be adapted to the opening end for much easier applying of the protective bag body, or removing of it for reuse or recycling.

### BACKGROUND OF THE INVENTION

The present invention is related to an improved fruit protective bag structure, comprising a protective bag body weaved by deep black PE plastic yarns and silver gray PE plastic yarns to form an insulating yarn layer interlacing with a reflective yarn layer with air-penetrating pores distributed at the surface thereof. Said protective bag body has an opening end and three other sealed edges wherein said opening end has a gathering string adapted thereto to seal up said opening end without any other extra string required. Via said opening end, said protective bag body can be easily and quickly applied onto fruit to shelter it therein or removed from it for reuse or recycling.

Please refer to FIG. 1. A conventional fruit protective bag 50 is mainly made up of a bag body 51 of non-woven fabric wherein said bag body 51 is provided with an opening 52 at one end and a sealed edge 54 at the other end thereof. A waterproof coat 53 is directly sprayed onto the section of said bag body 51 with said opening 52 thereof. A string 55 is then applied to said water-tight coat 53 to tie up said opening 52 thereof so as to shelter fruit 60 at said bag body 51 therein for protection.

There are some drawbacks to such conventional fruit protective bag 50. First, said waterproof coat 53 is applied to the finished bag body 51 thereof, which increases not only the cost but also the procedure of production. Second, said bag body 51 made up of non-woven fabric is poor at the drainage of water penetrated into said bag body 51 via said opening 52. Fruit 60 soaked in water tends to get rotten easily. Third, due to non-woven fabric, said bag body 51 is easy to absorb humidity in air, but poor at the ventilation of humidity, which is also unhealthy to fruit sheltered therein. Fourth, the soft fabric of said bag body 51 is not bug-proof which makes fruit sheltered therein easily plagued by insects. Fifth, said string 55 is additionally applied from outside so as to tie up said bag body 51 thereof, which is not only inconvenient but also boost the cost of production.

Please refer to FIG. 2. Another conventional fruit protective bag is mainly made up of a bag body 70 with an opening 72 disposed at one end thereof and a gap 71 properly disposed at one lateral side thereof A net-shaped piece 71 is disposed at said gap 71 thereof with a lift piece 73 attached thereto at one side at the outer layer of said bag body 70 thereof.

There are several disadvantages to such conventional fruit protective bag. First, it's complicated in processing and high in the cost of production. Second, said bag body 70 is sealed at the bottom without any draft pores to ventilate water or humidity in air, which may make fruit sheltered therein get rotten easily. Third, said bag body 70 is completely sealed without any air-penetrating pores disposed thereon, which is unhealthy to the growing of fruit and may even cause the death of fruit sheltered therein. Fourth, said bag body 70 lacks any flexibility, which may hinder the growing of fruit sheltered therein and ruin the outlook of said fruit due to the friction thereof. Fifth, an extra string is required so as to tie up the opening 72 of said bag body 70, which is not only inconvenient but also increase the cost of production.

### SUMMARY OF THE INVENTION

It is, therefore, the primary purpose of the present invention to provide an improved fruit protective bag structure, comprising a protective bag body weaved by deep black PE plastic yarns and silver gray PE plastic yarns to form an insulating yarn layer interlacing with a reflective yarn layer with air-penetrating pores distributed at the surface thereof wherein said insulating yarn layer can permanently absorb the ultraviolet ray of sunbeams, and said reflective yarn layer can send back sunbeams so as to prevent fruit sheltered therein from the damage of sunburn, providing a fruit protective bag with benefits of high air-penetrability, good ventilation of humidity, heat resistance, and heat-sinking capability as well as being recyclable.

It is, therefore, the second purpose of the present invention to provide an improved fruit protective bag structure having a multiple of air-penetrating pores disposed thereon, facilitating the drainage of water or ventilation of humidity and the penetration of air thereto so that, instead of getting rotten by water, fruit can get sufficient air and grow healthily therein.

It is, therefore, the third purpose of the present invention to provide an improved fruit protective bag structure wherein said insulating yarn layer interlacing with said reflective yarn layer is woven more closely at the inner side thereof to provide a smooth inner facet to shelter fruit therein without damaging the outlook of said fruit in grow, and woven more loosely at the outer side thereof to provide a rough protective facet to prevent the damages from insects. Moreover, the double-layer of said fruit protective bag also efficiently prevents the plagues of insects such as bug-biting.

It is, therefore, the fourth purpose of the present invention to provide an improved fruit protective bag structure wherein said fruit protective bag made up of PE yarns is flexible to provides a sufficient room for fruit to grow therein naturally and healthily without damaging its outlook.

It is, therefore, the fifth purpose of the present invention to provide an improved fruit protective bag structure wherein a gathering string is adapted to an opening end of said fruit protective bag thereof so as to seal up said opening end without any other extra string required so that said fruit protective bag can be easily and conveniently applied onto fruit to shelter it therein or quickly removed from it for reuse or recycling.

### BRIEF DESCRIPTION OF THE DRAWINGS

FIG. 1 is a diagram showing a conventional fruit protective bag in use.

FIG. 2 is a perspective view of a second conventional fruit protective bag.

FIG. 3 is a perspective view of the present invention.

FIG. 4 is a sectional and partially enlarged view of the present invention.

FIG. 5 is a diagram showing the reflection of sunbeams and the insulation of ultraviolet ray of the present invention.

FIG. 6 is another embodiment of the present invention.

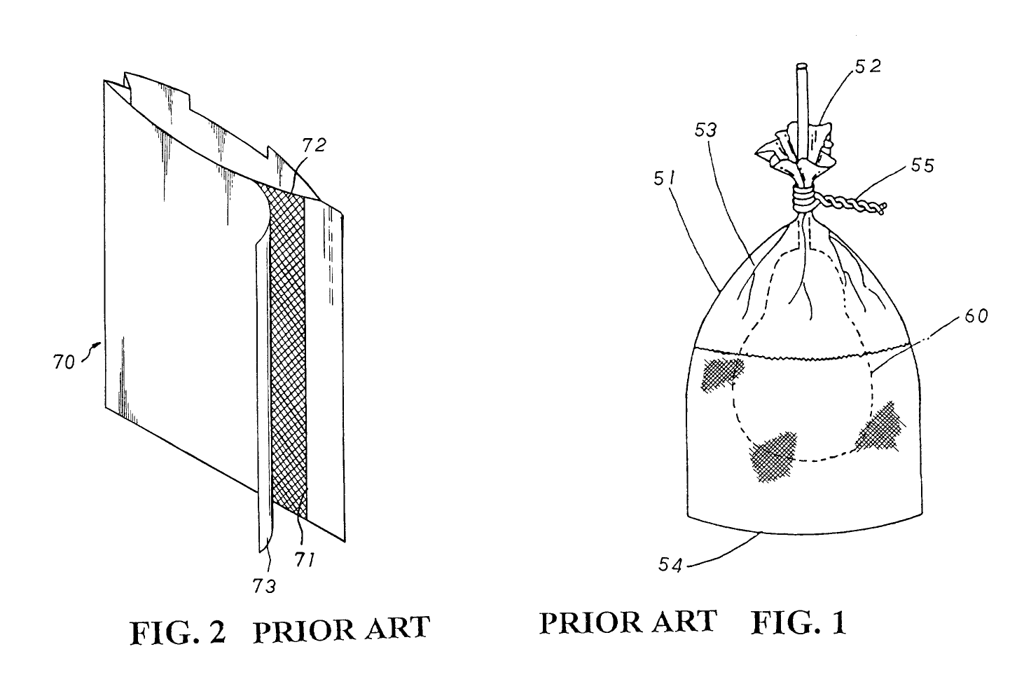

### DETAILED DESCRIPTION OF THE PREFERRED EMBODIMENTS

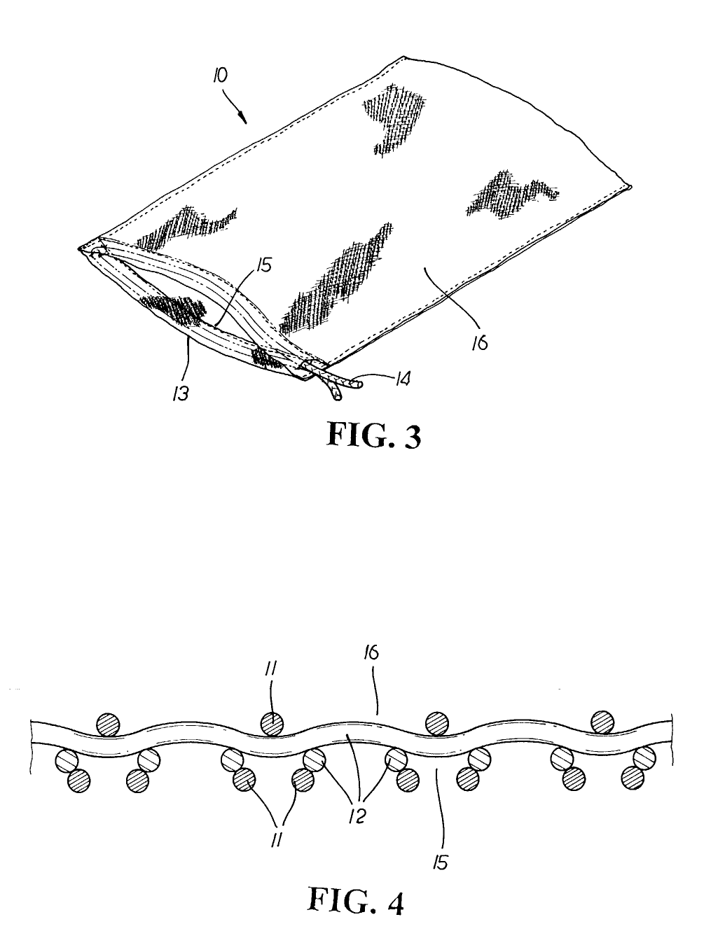

Please refer to FIG. 3. The present invention is related to an improved fruit protective bag structure, comprising a protective bag body 10 made up of deep black PE plastic yarns and silver gray PE plastic yarns with a multiple of small air-penetrating pores distributed thereon. Said deep black PE plastic yarns and silver gray PE plastic yarns thereof are weaved in crisscross manner to form an insulating yarn layer 11 interlacing with a reflective yarn layer 12 thereof. Said protective bag body 10 also includes an opening end 13 disposed at one edge thereof and three other sealed edges thereof. Said opening end 13 thereof has a gathering string 14 adapted thereto to collect and seal up the protective bag body 10 completely thereof without any other extra string required. Via said opening end 13, said protective bag body 10 can be economically recycled, applying easily onto the fruit to shelter it therein or removed quickly from it for further use.

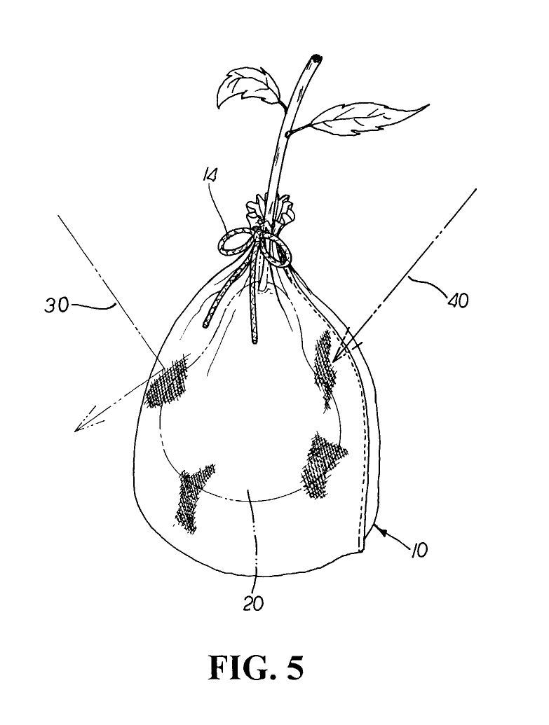

Please refer to FIG. 4. Said insulating yarn layer 11 interlacing with said reflective yarn layer 12 is weaved more closely at the inner side of said protective bag body 10 to form a smooth inner facet 15 thereof so as to safely shelter fruit therein, but weaved more loosely at the outer surface thereof to provide a rough protective facet 16 avoiding the damages of insects such as bug-biting from outside. The deep color of said insulating yarn layer 11 thereof can also permanently absorb the ultraviolet ray 40 of sunbeams 30, while the light color of said reflective yarn layer 12 can permanently send back sunbeams 30 to protect the fruit sheltered therein from the damage of sunburn as shown in FIG. 5. Said protective bag body 10 having small air-penetrating pores distributed thereon provides the benefits of high air-penetrability, good ventilation of humidity, heat resistance, heat-sinking capability, and bug-proof, boosting the efficiency in fruit cultivation. Moreover, said protective bag body 10 thereof can also be recycled, which is both conservational and economical.

Please refer to FIG. 5. In practical use, said protective bag body 10 is applied onto fruit 20 via said opening end 13 to shelter said fruit 20 therein. Said gathering string 14 thereof is then collected and tied up to seal up and locate said protective bag body 10 thereof onto said fruit 20 thereof for protection. The smooth inner facet 15 of said protective bag body 10 can safely shelter said fruit 20 therein, avoiding the damage of friction thereof, while the rough protective facet 16 thereof can guard the fruit 20 sheltered therein from the damage of insects. Moreover, the double-layer of PE plastic yarns interlacing together can also efficiently prevent the insects from biting at said protective bag body 10 from outside. Meanwhile, said insulating yarn layer 11 can completely absorb and insulate the ultraviolet ray 40 in sunbeams 30, and said reflective yarn layer 12 can send back the strong sunbeams 30, protecting said fruit 20 sheltered therein from the damage of sunburn as shown in FIG. 5.

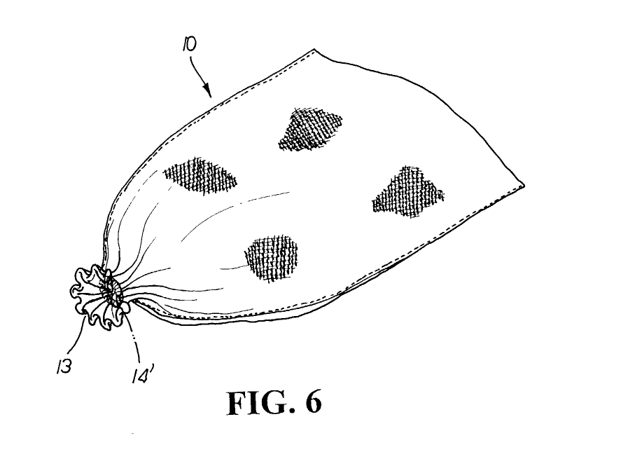

Please refer to FIG. 6. The opening end 13 of said protective bag body 10 can also be applied with a flexible gathering string 14′, forming a flexible opening end for much easier application of said protective bag body 10 onto fruit 20 thereof, or removing it thereof for reuse or recycling.

What is claimed is:

1. A protective bag structure, comprising a protective bag body made up of deep black PE plastic yarns and silver gray PE plastic yarns weaved in crisscross manner to form an insulating yarn layer interlacing with a reflective yarn layer with a multiple of small air-penetrating pores distributed at the surface thereon, said protective bag structure characterized by that,
said protective bag body having an opening end disposed at one edge thereof and three other sealed edges thereof wherein said opening end thereof having a gathering string adapted thereto to collect and seal up the protective bag body completely thereof without any other extra string required;
whereby, via said opening end, said protective bag body can be easily and quickly applied onto fruit to shelter it therein or removed from it for reuse or recycling; moreover, said insulating yarn layer thereof can absorb the ultraviolet ray of sunbeams, and said reflective yarn layer can send back sunbeams to protect the fruit sheltered therein from the damage of sunburn, facilitating the benefits of high air-penetrability, well ventilation of humidity, heat resistance, heat-sinking capability, and bug-proof.

2. The fruit protective bag structure as claimed in claim 1 wherein the gathering string of said opening end thereof can be easily drawn and tied up to seal up the opening end thereof to safely shelter fruit therein.

3. The fruit protective bag structure as claimed in claim 1 wherein a flexible gathering string can also be adapted to said opening end, forming a flexible opening end for much easier applying of said protective bag body, or removing of it for reuse or recycling.
